(19) United States
(12) Patent Application Publication
(10) Pub. No.: US 2014/0178117 A1
(43) Pub. Date: Jun. 26, 2014

(54) RECORDING APPARATUS

(71) Applicant: SEIKO EPSON CORPORATION, Tokyo (JP)

(72) Inventors: Hiroaki TAKEI, Matsumoto-shi (JP); Takayuki IIJIMA, Shiojiri-shi (JP)

(73) Assignee: SEIKO EPSON CORPORATION, Tokyo (JP)

(21) Appl. No.: 14/132,553

(22) Filed: Dec. 18, 2013

(30) Foreign Application Priority Data
Dec. 25, 2012 (JP) 2012-281571

(51) Int. Cl. B41J 11/66

(52) U.S. Cl. CPC B41J 11/66
USPC 400/621

(57) ABSTRACT

A recording apparatus includes a recording unit that performs recording onto a medium, a housing that houses the recording unit, a drawer unit that includes a finger-hooking portion and is accommodated in the housing so as to be capable of being drawn out, a cutter that cuts the medium inside the housing, and a container that is detachably attached to the housing and includes a container unit that can contain a cut piece of the medium that is produced when the cutter performs cutting. In the recording apparatus, the container covers the finger-hooking portion of the drawer unit accommodated in the housing when the container is fitted into the housing, and the finger-hooking portion of the drawer unit accommodated in the housing is exposed when the container is removed from the housing.

### BACKGROUND

1. Technical Field

The present invention relates to a recording apparatus provided with a container that contains a cut piece that is produced as a result of cutting the medium.

2. Related Art

As an example of a recording apparatus, there is a printer that is provided with a drawer section that accommodates a long sheet of paper that is wound in a cylindrical shape into a roll state, a cutter that cuts the sheet of paper on which printing has been performed, and a container that contains a cut piece such as a cutting chip that is produced as a result of cutting the sheet of paper.

In such a printer, when the cut pieces that have accumulated in the container fall out, the cut pieces scatter inside the housing. Accordingly, in order to create an opportunity to empty the container, a configuration has been proposed in which removal of the container is encouraged at the time the roll is replaced. For example, there is a printer that allows a roll to be replaced only when a container is removed from a drawer section and, further, when a roller that is arranged on an upper portion of the drawer section is moved to the position where the container had been mounted (JP-A-2003-182172, for example).

In order to encourage the removal of the container, the printer described above includes a pivoting plate that supports the roller, a locking mechanism that locks the pivoting plate, and an operation rod for manually operating the pivoting plate; disadvantageously, the configuration of the device becomes complex.

Note that the above problem is not limited to printers that perform printing on a sheet of paper but is a problem that is generally common among recording apparatuses that is provided with a container that is capable of containing cut pieces of medium.

### SUMMARY

An advantage of some aspects of the invention is to provide a recording apparatus that has a simple configuration and that is capable of encouraging removal of a container.

According to an aspect of the invention, a recording apparatus includes a recording unit that performs recording onto a medium, a housing that houses the recording unit, a drawer unit that includes a finger-hooking portion and is accommodated in the housing so as to be capable of being drawn out, a cutter that cuts the medium inside the housing, and a container that is detachably attached to the housing and includes a container unit that can contain a cut piece of the medium that is produced when the cutter performs cutting. In the recording apparatus, the container covers the finger-hooking portion of the drawer unit accommodated in the housing when the container is fitted into the housing, and the finger-hooking portion of the drawer unit accommodated in the housing is exposed when the container is removed from the housing.

According to such a configuration, the finger-hooking portion of the drawer unit becomes exposed when the container is removed from the housing. Accordingly, the user can be encouraged to remove the container before drawing out the drawer unit. In other words, the position where the container is fitted is set at a position where the finger-hooking portion is covered; accordingly, it is possible to encourage the user to remove the container while suppressing an increase in the number of parts and while having a simple configuration.

In the recording apparatus described above, the drawer unit may further include side wall portions that rotatably support a roll that is the medium wound in a cylindrical shape and a front plate that is positioned in front of the roll in a direction of drawing out the drawer unit from the housing. Furthermore, the finger-hooking portion may be arranged in the front plate and the front plate may be arranged below a rotation center of the roll in the direction of gravity.

According to such a configuration, the drawer unit rotatably supports the roll; accordingly, removal of the container can be encouraged at the time the drawer unit is drawn out and the roll is replaced. Furthermore, the front plate is arranged below the rotation center of the roll in the gravitational direction; accordingly, replacing work of the roll that is carried out above the front plate is facilitated. In addition, the finger-hooking portion is arranged in the front plate; accordingly, a finger can be hooked onto the finger-hooking portion without placing the hand deep in the housing.

In the recording apparatus described above, the drawer unit may be drawn out through an opening formed in the housing, and the container may further include an outer wall portion that covers the opening when the container is fitted into the housing and an inner wall portion that forms the container unit between the inner wall portion and the outer wall portion.

According to such a configuration, the outer wall portion of the container covers the opening when the container is fitted into the housing; accordingly, there is no need to separately provide a cover that covers the opening of the housing. Accordingly, an increase in the number of parts can be suppressed.

In the recording apparatus described above, when the container is fitted into the housing, the opening may be covered by the outer wall portion and the front plate, and an outer surface of the outer wall portion may be flush with an outer surface of the front plate.

According to such a configuration, when the container is fitted into the housing, the opening is covered by the outer wall portion and the front plate and, further, the outer surface of the outer wall portion is flush with the outer surface of the front plate; accordingly, it is difficult to hook a finger onto the front plate when the container has been attached to the housing. Thus, it is possible to prevent the drawer unit alone from being drawn out without the container being removed. Furthermore, when the container is fitted into the housing, since the outer wall portion of the container and the front plate of the drawer unit that cover the opening are flush with each other, a sense of unity of the housing can be created.

In the recording apparatus described above, the container may be attached at a position that is in line, in the direction of gravity, with the front plate of the drawer unit that is accommodated in the housing, and a length of the outer wall portion and a length of the front plate in a width direction that intersects both the direction of gravity and the direction of drawing out the drawer unit may be the same.

According to such a configuration, when the container is fitted into the housing, the length of the front plate of the drawer unit and that of the outer wall portion of the container that align in the gravitational direction are the same in the width direction; accordingly, a sense of unity of the housing can be created.

### BRIEF DESCRIPTION OF THE DRAWINGS

The invention will be described with reference to the accompanying drawings, wherein like numbers reference like elements.

FIG. 1 is a perspective view illustrating a configuration of a recording apparatus of a first exemplary embodiment.

FIG. 2 is a cross-sectional view illustrating the configuration of the recording apparatus of the first exemplary embodiment.

FIG. 3 is a perspective view for describing functions of the recording apparatus of the first exemplary embodiment.

FIG. 4 is a perspective view illustrating a configuration of a recording apparatus of a second exemplary embodiment.

FIG. 5 is a cross-sectional view illustrating the configuration of the recording apparatus of the second exemplary embodiment.

### DESCRIPTION OF EXEMPLARY EMBODIMENTS

An exemplary embodiment of a recording apparatus will be described below with reference to the drawings.

### First Exemplary Embodiment

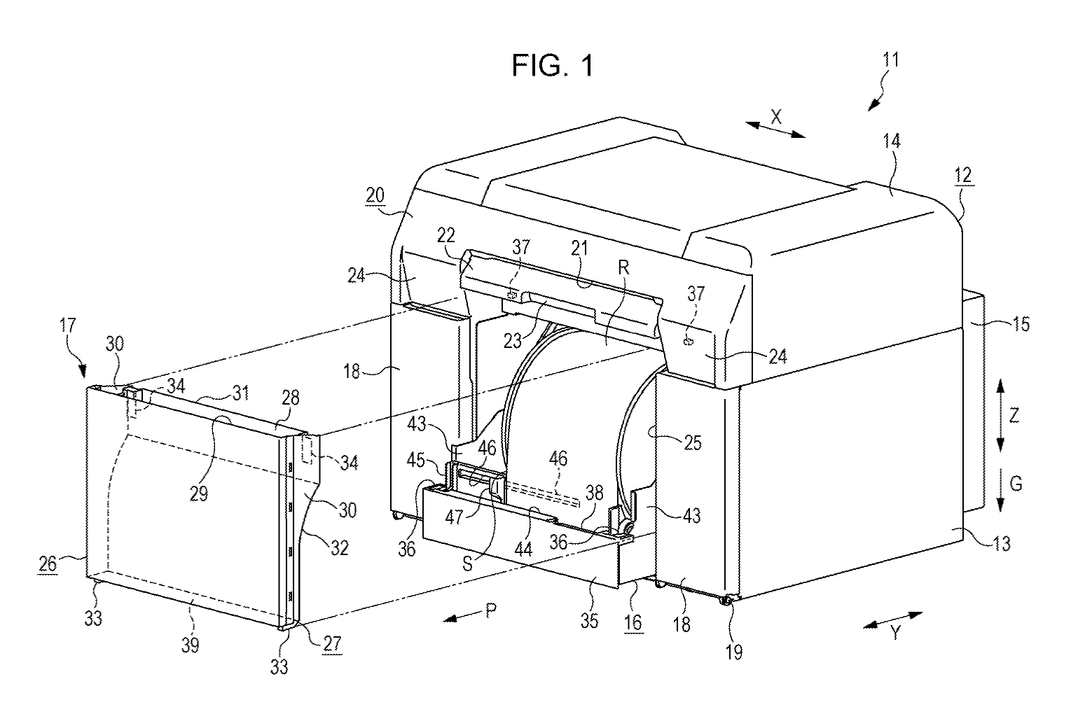

As illustrated in FIG. 1, a recording apparatus 11 of the first exemplary embodiment includes a housing 12 having a substantially rectangular box shape. The housing 12 includes a first container unit 13, a second container unit 14 that is arranged on the upper side of the first container unit 13, and a third container unit 15 that is arranged on the rear side of the first container unit 13. Note that in the first exemplary embodiment, a front-rear direction Y denotes the direction in which the second container unit 14 and the third container unit 15 are arranged, which is a direction that intersects (orthogonal in the first exemplary embodiment) an up-down direction Z that extends in the gravitational direction G. Furthermore, a width direction X denotes a longitudinal direction of the first container unit 13 and the second container unit 14 that intersects (orthogonal in the first exemplary embodiment) the gravitational direction G and the front-rear direction Y.

A drawer unit 16 is accommodated in the housing 12 so as to be capable of being drawn out through an opening 25 formed around the center of the first container unit 13 in the width direction X. The drawer unit 16 has a front plate 35 whose outer surface (front side in the first exemplary embodiment) is exposed when the drawer unit 16 is accommodated in the housing 12. Note that the front plate 35 does not necessarily have to be formed of a single plate-like member, and a plurality of members may be combined, such as, for example, employing an outer surface side member and an inner surface side member that are formed of different materials from each other.

A container 17 is detachably attached at a position that is in line in the gravitational direction G with the front plate 35 of the drawer unit 16 that is accommodated in the housing 12 and at a position that is above the front plate 35. The container 17 has an outer wall portion 26 that covers the opening 25 when the container 17 is fitted into the housing 12 and an inner wall portion 27 that forms a container unit 28 between the inner wall portion 27 and the outer wall portion 26. When the container 17 is fitted into the housing 12, the inner wall portion 27 is arranged inside the housing 12.

The drawer unit 16 has a finger-hooking portion 38, which allows a finger to be hooked thereto when pulling the container 17 out from the housing 12, arranged on the inner surface side of the front plate 35. The finger-hooking portion 38 is a concavity formed, for example, on a first end side (the right side in FIG. 1) of the front plate 35 in the width direction X. The finger-hooking portion 38 does not necessarily have to be integrally formed with the front plate 35. The finger-hooking portion 38 may be formed by combining a separate member with the front plate 35.

When the container 17 is fitted into the housing 12, the container 17 covers the finger-hooking portion 38 of the drawer unit 16 that is accommodated in the housing 12. On the other hand, when the container 17 is removed from the housing 12, the finger-hooking portion 38 of the drawer unit 16 that is accommodated in the housing 12 becomes exposed.

When the container 17 is fitted into the housing 12, the opening 25 is covered by the outer wall portion 26 and the front plate 35. At this time, the outer surface of the outer wall portion 26 becomes flush with the outer surface of the front plate 35. In other words, the outer wall portion 26 of the container 17 and the front plate 35 of the drawer unit 16 function as the housing of the recording apparatus 11. Note that “flush” used in the disclosure and the first exemplary embodiment not only denotes a completely flush state in which there is no level difference between the outer surface of the outer wall portion 26 and the outer surface of the front plate 35, but also includes a state in which the outer surface of the outer wall portion 26 and the outer surface of the front plate 35 appear to be substantially flush when observed visually.

The length of the outer wall portion 26 and that of the front plate 35 in the width direction X that intersect both the gravitational direction G and a drawing out direction P (the front direction in the first exemplary embodiment) of the drawer unit 16 are the same. Furthermore, the outer wall portion 26 is longer than the front plate 35 in the gravitational direction G.

The inner wall portion 27 of the container 17 includes a pair of side walls 30 that are joined to the two end sides of the outer wall portion 26 in the width direction X, a substantially rectangular plate-shaped inner wall 31 that forms a receiving opening 29 with the upper end portion of the outer wall portion 26, a curved wall 32 that extends downward from the lower end side of the inner wall 31 so as to curve in a direction that approaches the outer wall portion 26, and a bottom wall 39 that is joined to the lower end portion of the outer wall portion 26. The container 17 further includes a pair of metal pieces 34 that are attached to the two end sides of the inner wall 31 in the width direction X.

The container 17 includes a pair of engagement projections 33 that protrude downward at the two end sides of the bottom wall 39 in the width direction X. On the other hand, the front plate 35 of the drawer unit 16 includes a pair of support recesses 36 that open upward at the two end sides of the front plate 35 in the width direction X. When the container 17 is fitted into the housing 12, the container 17 is supported by the front plate 35 in a state in which the engagement projections 33 are engaged with the support recesses 36.

The drawer unit 16 supports a path forming member 45 that forms an insertion opening 44 between the path forming member 45 and the front plate 35. The path forming member 45 includes a guide hole 46 that extends in the width direction X from a second end side (the left side in FIG. 1) to the first end side (the right side in FIG. 1).

The path forming member 45 supports a positioning member 47 that is movable along the guide hole 46 in the width direction X. The positioning member 47 includes a protrusion that protrudes in the drawing out direction P with respect to the guide hole 46. Note that in the drawer unit 16, the finger-hooking portion 38 is arranged on the first end side (the right side in FIG. 1) in the width direction X with respect to the movable range of the protrusion of the positioning member 47.

When the container 17 is removed from the housing 12 and the drawer unit 16 is drawn out in the drawing out direction P by hooking a finger onto the finger-hooking portion 38, a pair of side wall portions 43 that are included in the drawer unit 16 are moved to the outside of the housing 12. The side wall portions 43 rotatably support, for example, a roll R that is a sheet-like medium S, such as a sheet of paper, wound in a cylindrical shape. Note that, the front plate 35 is positioned in front of the roll R and the side wall portions 43 in the drawing out direction P of the housing 12.

A roll R that is one among a plurality of rolls R that have different numbers of windings and lengths (widths) in the width direction X is loaded onto the drawer unit 16 in a replaceable manner in which the roll R is aligned with the first end side in the width direction X. The length of the guide hole 46 and the movable range of the positioning member 47 in the width direction X are set according to the minimum width of the roll R that can be loaded onto the drawer unit 16.

An opening/closing cover 18 is attached in a pivotal manner to each end side of the first container unit 13 in the width direction X. Each opening/closing cover 18 is arranged in a closed position as illustrated in FIG. 1 when the upper end side thereof pivots about a pivotal shaft 19 that is provided at the lower end side of the opening/closing cover 18 and is arranged in an open position that exposes the inside when the upper end portion of the opening/closing cover 18 is pivoted forward. When the opening/closing cover 18 is arranged in the open position, a cartridge holder (not shown) that has ink cartridges (not shown) detachably mounted therein, which contain ink that is an example of the liquid, becomes exposed.

A frame member 20 that constitutes the housing 12 is arranged on the front side of the second container unit 14 at the upper side of the container 17 and the opening/closing covers 18. A discharge opening 21 that is open obliquely downward is formed around the center of the frame member 20 in the width direction X. A guide portion 22 that is curved so as to be concaved inward from its lower end side towards its upper portion on the discharge opening 21 side is formed in the frame member 20 below the discharge opening 21. Furthermore, in the frame member 20, a pair of magnets 37 are attached at positions below the guide portion 22 and on the inner side of the housing 12 with respect to the guide portion 22.

A lower end side concavity 23 that is open downward and to the front is formed in the guide portion 22 at the lower end portion and around the center thereof in the width direction X. When the container 17 is attached to the housing 12, the upper end portion of the outer wall portion 26 is exposed through the lower end side concavity 23.

A pair of recess portions 24 that become more recessed toward the inner side of the housing 12 as the recess portions 24 extend to the lower end side and that open toward the front and toward the inside, which is the container 17 side, are formed at the two end sides of the frame member 20 in the width direction X. The two end sides in the width direction X of the container 17 that is attached to the housing 12, and the upper end portion of the opening/closing cover 18 that is in the closed position are exposed through the recess portions 24.

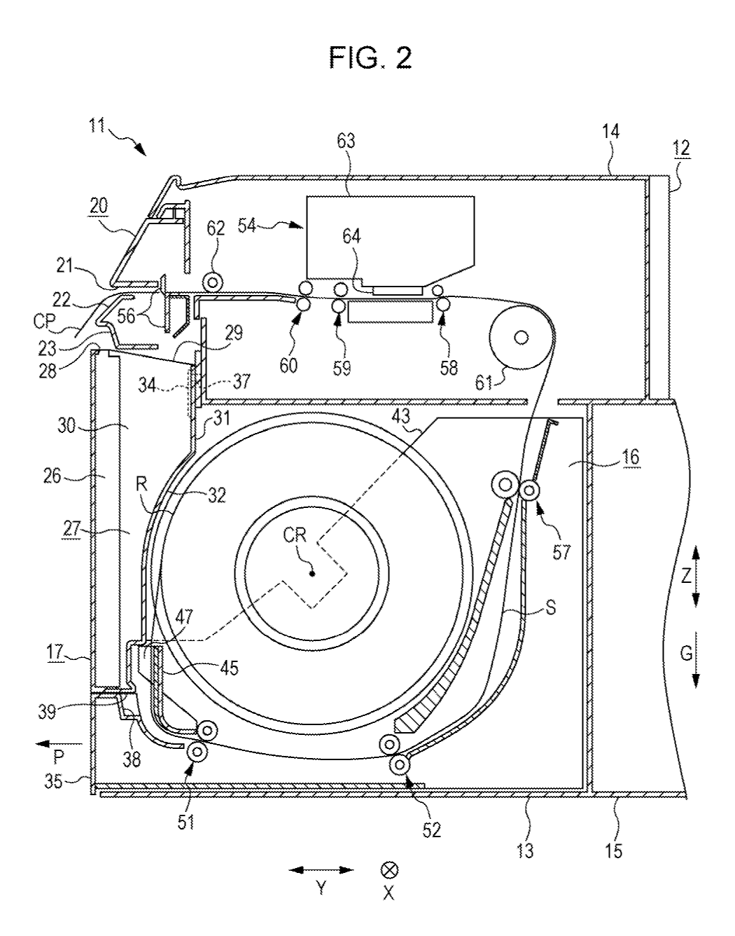

As illustrated in FIG. 2, the drawer unit 16 holds pairs of transport rollers 51, 52, and 57 therein that transport the medium S, which has been unwound from the roll R, in the transport direction that extends towards the second container unit 14 side. Furthermore, the second container unit 14 houses therein pairs of transport rollers 58, 59, and 60 that transport the medium S in the transport direction that extends towards the discharge opening 21, an intermediate roller 61 that is arranged upstream of the pair of transport rollers 58 in the transport direction, and a discharge roller 62 that is arranged downstream of the pair of transport rollers 60 in the transport direction. Note that the front plate 35 and the pairs of transport rollers 51 and 52 are arranged below a rotation center CR of the roll R in the gravitational direction G.

The recording apparatus 11 includes, inside the second container unit 14, a recording unit 54 that carries out recording by ejecting ink, which is an example of the liquid, onto the medium S and a cutter 56 that cuts the medium S inside the housing 12.

The recording unit 54 includes a carriage 63 that is capable of reciprocating in the width direction X and a liquid ejecting unit 64 that is arranged on the lower portion of the carriage 63. The medium S that has been subjected to recording (printing) by the recording unit 54 is cut with the cutter 56 per unit length. Accordingly, the medium S turns into cut paper CP. The cut paper CP, the recording of which has been completed, is discharged outside the housing 12 through the discharge opening 21.

When the cutter 56 cuts the medium S, a blank space portion is cut off, the blank space portion being a portion between the rear end of a cut paper CP that has been cut recently and the front end of a cut paper CP that is to be cut next. Accordingly, the cut piece of the blank space portion drops down as a cutting chip. At this time, the receiving opening 29 and the container unit 28 of the container 17 is arranged below the cutter 56. Accordingly, the container 17 is capable of containing therein cut pieces of the medium S that are produced when the cutter 56 carries out cutting.

Functions of the recording apparatus 11 of the first exemplary embodiment configured as above will be described next.

When the roll R is to be loaded into the drawer unit 16, as illustrated in FIG. 1, the drawer unit 16 is drawn out and the roll R is set onto the side wall portions 43. Then, the leading edge of the medium S that has been unwound from the roll R is manually inserted into the insertion opening 44. Next, the positioning member 47 is moved so that the medium S is positioned on the first end side in the width direction X.

Note that in the drawer unit 16, since the finger-hooking portion 38 is arranged on the first end side (the right side in FIG. 1) in the width direction X with respect to the movable range of the protrusion of the positioning member 47, the positioning member 47 that protrudes in the drawing out direction P does not get in the way when a finger is hooked onto the finger-hooking portion 38.

When the loading of the roll R onto the drawer unit 16 is completed, the drawer unit 16 is accommodated in the housing 12 and the container 17 is attached to the housing 12. When the container 17 is fitted into the housing 12, the engagement projections 33 that are formed on the lower end side of the container 17 are engaged with the support recesses 36 of the drawer unit 16. Then, the upper end side of the container 17 is moved towards the frame member 20 side while the engagement projections 33 act as the point of support of the container 17. Accordingly, the container 17 is supported by the front plate 35 through the engagement projections 33, and, furthermore, the metal pieces 34 are attracted to the magnets 37 such that a self-standing state of the container 17 is maintained in which the receiving opening 29 faces the upper side.

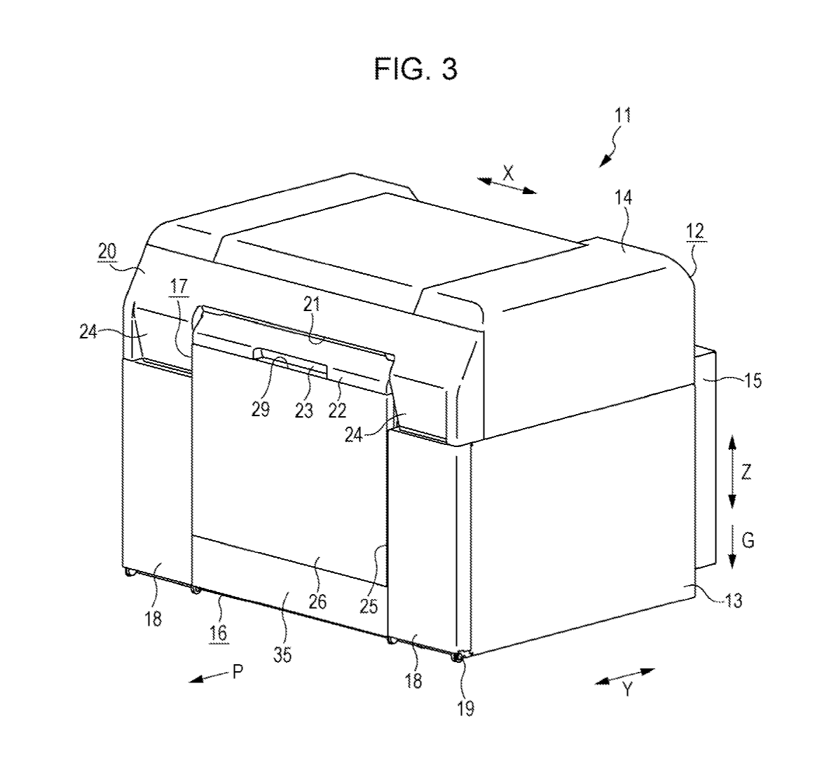

As illustrated in FIG. 3, the recording apparatus 11 performs recording in a state in which the drawer unit 16 is accommodated in the housing 12 and in which the container 17 is attached to the housing 12. In a state in which the container 17 is attached to the housing 12, the finger-hooking portion 38 illustrated in FIGS. 1 and 2 cannot be visually observed or touched.

Accordingly, as illustrated in FIG. 1, the container 17 is removed from the housing 12 first when the roll R is to be loaded onto the drawer unit 16 or when the roll R is to be replaced. This exposes the finger-hooking portion 38 of the drawer unit 16 that is accommodated in the housing 12, and thus, it will be possible to hook a finger onto the finger-hooking portion 38 and draw out the drawer unit 16 in the drawing out direction P.

Note that when removing the container 17 from the housing 12, as illustrated in FIG. 3, a finger can be hooked onto the upper end portion of the container 17 that is exposed through the lower end side concavity 23. Furthermore, a finger can be hooked onto the end portions of the container 17 in the width direction X that are exposed through the recess portions 24. Additionally, when attaching/detaching an ink cartridge, each opening/closing cover 18 can be pivoted by hooking a finger onto the upper portions of the opening/closing cover 18 that is exposed through the corresponding recess portion 24.

As illustrated in FIG. 2, when the medium S is cut by the cutter 56 in the recording apparatus 11, cut pieces of medium S accumulate in the container unit 28 of the container 17. Accordingly, the container 17 needs to be emptied of its contents, such as disposing the cut pieces that have accumulated in the container unit 28, before the container unit 28 becomes full.

Note that the container 17 is shaped such that the upper end side of the inner wall portion 27 protrudes more to the outer side of the container unit 28 with respect to the lower end side of the inner wall portion 27; accordingly, the container 17 cannot stand by itself when removed from the housing 12. Thus, when a user removes the container 17 from the housing 12, the container unit 28 is emptied, and the cut pieces are disposed of. In other words, the recording apparatus 11 includes a configuration that encourages the user to remove the container 17 before drawing out the drawer unit 16 by covering the finger-hooking portion 38 with the container 17 and, further, encourages the user to empty the container unit 28 when the container 17 is removed.

The following effects can be obtained by the exemplary embodiment described above.

(1) The finger-hooking portion 38 of the drawer unit 16 becomes exposed when the container 17 is removed from the housing 12. Accordingly, the user can be encouraged to remove the container 17 before drawing out the drawer unit 16. In other words, the position where the container 17 is fitted is set at a position where the finger-hooking portion 38 is covered; accordingly, it is possible to encourage the user to remove the container 17 while suppressing an increase in the number of parts and while maintaining a simple configuration.

(2) The drawer unit 16 rotatably supports the roll R; accordingly, removal of the container 17 can be encouraged at the time the drawer unit 16 is drawn out and the roll R is replaced. Furthermore, the front plate 35 is arranged below the rotation center CR of the roll R in the gravitational direction G; accordingly, replacing work of the roll R carried out above the front plate 35 is facilitated without the need to lift the heavy roll R up high. In addition, the finger-hooking portion 38 is arranged on the inner surface side of the front plate 35; accordingly, a finger can be hooked to the finger-hooking portion 38 without the need to place the hand deep in the housing 12.

(3) The outer wall portion 26 of the container 17 covers the opening 25 when the container 17 is fitted into the housing 12; accordingly, there is no need to separately provide a cover that covers the opening 25 of the housing 12. Accordingly, an increase in the number of parts can be suppressed.

(4) When the container 17 is fitted into the housing 12, the opening 25 is covered by the outer wall portion 26 and the front plate 35 and, further, the outer surface of the outer wall portion 26 is flush with the outer surface of the front plate 35; accordingly, it is difficult to hook a finger onto the front plate 35 when the container 17 is attached to the housing 12. Thus, it is possible to prevent the drawer unit 16 alone from being drawn out without the container 17 being removed. Furthermore, when the container 17 is fitted into the housing 12, since the outer wall portion 26 of the container 17 and the front plate 35 of the drawer unit 16 that cover the opening 25 are flush with each other, a sense of unity of the recording apparatus 11 as a housing can be created.

(5) When the container 17 is fitted into the housing 12, the length of the front plate 35 of the drawer unit 16 and that of the outer wall portion 26 of the container 17 that are aligned in the gravitational direction G are the same in the width direction X; accordingly, a sense of unity of the recording apparatus 11 as a housing can be created.

### Second Exemplary Embodiment

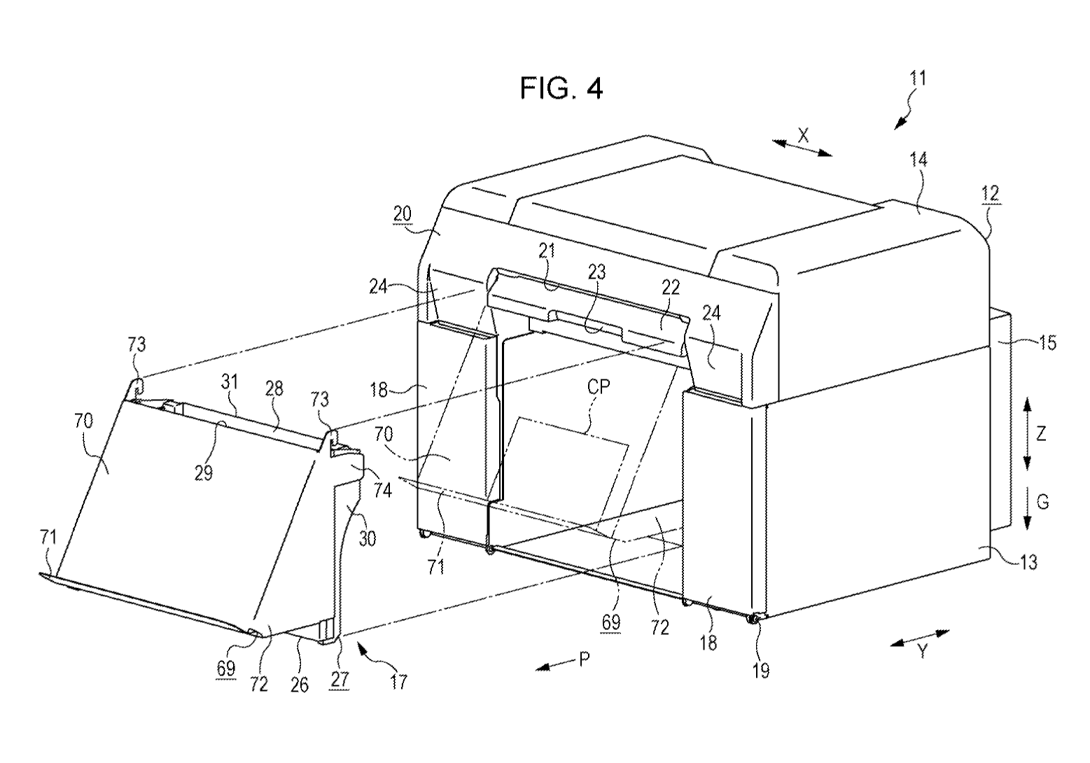

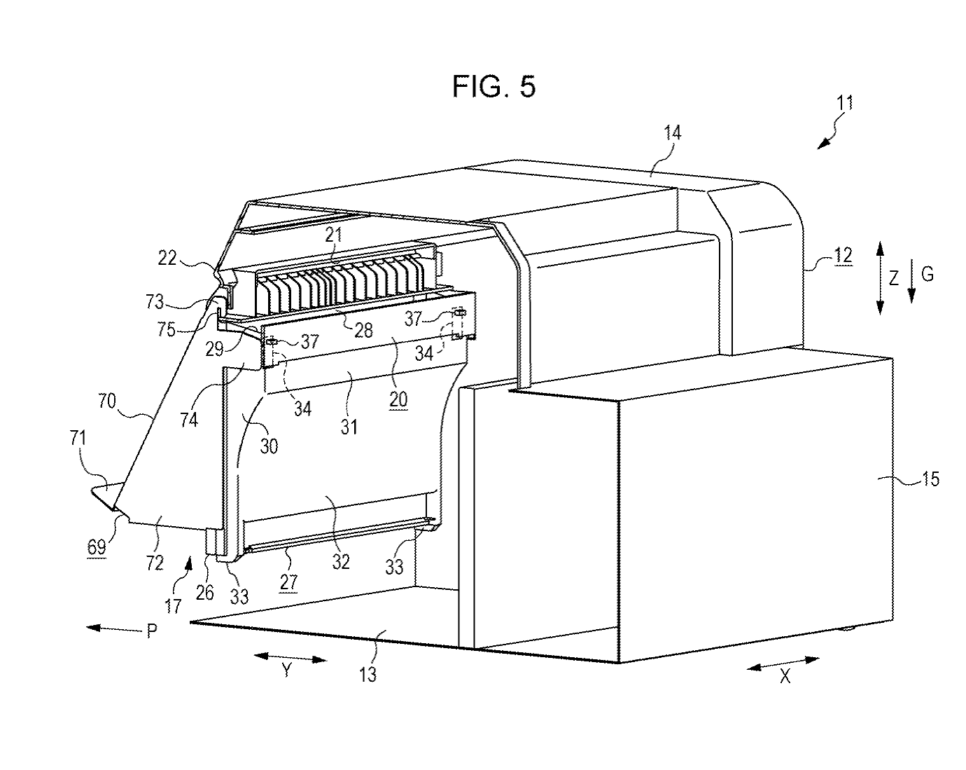

A second exemplary embodiment of the invention will be described next with reference to FIGS. 4 and 5.

As illustrated in FIG. 4, the recording apparatus 11 of the second exemplary embodiment is different from the first exemplary embodiment in that a medium receiving member 69 is integrated with the container 17 of the first exemplary embodiment. In FIGS. 4 and 5, in order to explicitly illustrate the configuration of the medium receiving member 69, the illustrations of the drawer unit 16 illustrated in each of FIGS. 1 to 3 are omitted.

The medium receiving member 69 includes a guide plate portion 70 that is inclined so as to protrude more to the front as it extends to the lower end side, a medium receiving portion 71 that is formed from the lower end side of the guide plate portion 70 to bend upward, and a pair of connecting plate portions 72 that are formed on the two end sides of the guide plate portion 70 in the width direction X. The paired connecting plate portions 72 include a pair of engaging hook portions 73 that are provided so as to upwardly protrude and a pair of holding portions 74 that are extended toward the inner wall 31 side. The medium receiving member 69 is attached to the container 17 in a manner in which the guide plate portion 70 covers the outer wall portion 26 and, further, in which the connecting plate portion 72 and the holding portions 74 hold the side walls 30 therebetween. Accordingly, the medium receiving member 69 is integrated with the container 17.

The frame member 20 includes spaces that are formed between the guide portion 22 and each of the recess portions 24 at the two end sides of the guide portion 22 in the width direction X. When the medium receiving member 69 is attached to the housing 12 together with the container 17, the engaging hook portions 73 are inserted into the spaces between the guide portion 22 and the recess portions 24.

As illustrated in FIG. 5, the frame member 20 includes a pair of support protrusions 75 that are provided so as to upwardly protrude in the spaces at the two end sides of the guide portion 22 in the width direction X. When the medium receiving member 69 that has been integrated with the container 17 is fitted into the housing 12, the engaging hook portions 73 that have been inserted into the spaces are engaged with the support protrusions 75 of the frame member 20.

Functions of the recording apparatus 11 of the second exemplary embodiment that is configured as above will be described next.

As illustrated by two-dot chain lines in FIG. 4, when the container 17 that has been integrated with the medium receiving member 69 is attached to the housing 12, the guide plate portion 70 is arranged below the guide portion 22. The cut paper CP that has been discharged from inside the housing 12 through the discharge opening 21 is guided toward the guide plate portion 70 by the guide portion 22 and slips down along the guide plate portion 70 to the medium receiving portion 71. Accordingly, the cut paper CP, the recording of which has been completed, can be received by the guide plate portion 70 and the medium receiving portion 71 without falling to the floor surface.

According to the second exemplary embodiment described above, in addition to the above described effects (1) to (5), the following effects can be obtained.

(6) The medium receiving member 69 protrudes forward with respect to the container 17; accordingly, the container 17 can be easily removed from the housing 12 by holding the medium receiving member 69.

(7) When the container 17 is removed from the housing 12, the medium receiving member 69 supports the container 17; accordingly, the container 17 can stand by itself.

Note that the following changes can be made to the second exemplary embodiment described above.
The medium receiving member 69 may be integrally formed with the container 17.
The medium receiving member 69 may include a storing concavity that stores the cut paper CP.
The metal pieces 34 of the container 17 and the magnets 37 of the frame member 20 may not be provided.

The following changes may be further made to each of the exemplary embodiments described above.
Not limited to the cut piece, such as the cutting chips that are to be disposed, the container 17 may be configured to contain the cut paper CP therein.
The recording unit 54 may carry out recording onto the medium S that has been cut by the cutter 56.
The drawer unit 16 may hold the cartridge holder that allows the ink cartridges to be detachably mounted. According to such a configuration, the user can be encouraged to remove the container 17 at the time the ink cartridge is replaced.
The recording apparatus 11 may be configured to carry out printing to a sheet of cut paper CP that has been cut in advance into a predetermined length. In such a case, the drawer unit 16 may be configured to retain the cut paper CP that is to be printed. According to such a configuration, the user can be encouraged to remove the container 17 at the time the drawer unit 16 is drawn out to replenish the cut paper CP.
The finger-hooking portion 38 is not limited to a concavity that is concavely provided in the front plate 35 but may be a gripping portion protrudingly provided in the front plate 35. Alternatively, the plate-shaped front plate 35 may be used, as a finger-hooking portion 38, without changing the shape of the inner surface side thereof.
The length of the outer wall portion 26 and that of the front plate 35 in the width direction X may be different from each other.
When the container 17 is fitted into the housing 12, the outer surface of the outer wall portion 26 and the outer surface of the front plate 35 do not need to be flush with each other. In such a case, a sense of unity of the recording apparatus 11 as a housing can also be created by applying a similar surface treatment or by applying a similar color to each of the outer surface of the housing 12, the outer wall portion 26, and the front plate 35, or by forming a flat surface or curved surface that continues through each of the outer surfaces, for example.
The drawer unit 16 may include a finger-hooking portion 38 that extends in the gravitational direction G, and the user may hook a finger onto the finger-hooking portion 38 while the palm of the user faces a direction other than the gravitational direction G, such as, for example, a lateral direction that is the width direction X. Furthermore, in such a case, the position into where the container 17 is fitted may be set so that the outer wall portion 26 and the front plate 35 align in the width direction X.
For example, a portion or all of the container 17 may be configured with a transparent member, and a portion or all of the finger-hooking portion 38 may be configured to be visible when the container 17 is fitted into the housing 12. According to such a configuration, although it will not be possible to hook a finger onto the finger-hooking portion 38 when the container 17 is fitted into the housing 12, it will be possible to visually confirm the position of the finger-hooking portion 38; accordingly, it will be possible to imply how to operate the drawer unit 16 to the user.
The finger-hooking portion 38 may be provided on the lower end side of the front plate 35, and the user may hook a finger onto the finger-hooking portion 38 while the palm of the user faces upward. In such a case, the position into where the container 17 is fitted may be set below the front plate 35.
The configuration may be such that the front plate 35 is unexposed to the outside of the housing 12 when the container 17 is fitted into the housing 12 and the drawer unit 16 becomes visible when the container 17 is removed. Furthermore, when the front plate 35 is unexposed to the outside of the housing 12 when the container 17 is fitted into the housing 12, the finger-hooking portion 38 may be arranged at a position other than the inner surface side of the front plate 35, such as the front side or the upper surface side of the front plate 35.
A cover that covers the container 17 that is attached to the housing 12 may be provided, and the container 17 may be in a removable state when this cover is removed.
The upper end of the front plate 35 may be arranged above the rotation center CR of the roll R in the gravitational direction G.
The medium S is not limited to a sheet of paper and may be a plastic film or a plate material. Alternatively, the medium S may be fabric used in printing devices.
In each of the exemplary embodiments described above, the recording apparatus may be a fluid ejecting device that performs recording by ejecting or discharging a fluid other than ink such as a liquid, a liquid substance containing particles of functional material dispersed or mixed in liquid, or a fluid body such as a gel, as well as solids that can be made to flow and be ejected as a fluid. For example, the recording apparatus may be a liquid substance ejecting device that performs recording by ejecting a liquid substance including, in a dispersed or dissolved manner, a material, such as electrode material or a color material (a pixel material), that is used to manufacture liquid crystal displays, electroluminescence (EL) displays, and surface-emitting displays. Furthermore, the recording apparatus may be a fluid body ejecting device that ejects a fluid body such as a gel (a physical gel, for example), or a particulate matter ejecting device (a toner jet recording apparatus, for example) that ejects solids, for example, a powder (particulate matter) such as a toner. The present invention can be applied to either one of the types of the fluid ejecting devices. Note that in the present specification, “fluid” is a concept that excludes fluids containing gas alone, and the meaning of fluid includes, for example, a liquid (including an inorganic solvent, an organic solvent, solution, a liquid resin, a liquid metal (metal melt), and the like), a liquid substance, a fluid body, and a particulate matter (including grain and powder).

The entire disclosure of Japanese Patent Application No. 2012-281571, filed Dec. 25, 2012 is expressly incorporated by reference herein.

What is claimed is:

1. A recording apparatus, comprising:
a recording unit that performs recording onto a medium;
a housing that houses the recording unit;
a drawer unit that includes a finger-hooking portion and is accommodated in the housing so as to be capable of being drawn out;
a cutter that cuts the medium inside the housing; and
a container that is detachably attached to the housing and includes a container unit that can contain a cut piece of the medium that is produced when the cutter performs cutting, wherein
the container covers the finger-hooking portion of the drawer unit accommodated in the housing when the container is fitted into the housing, and the finger-hooking portion of the drawer unit accommodated in the housing is exposed when the container is removed from the housing.

2. The recording apparatus according to claim 1, wherein
the drawer unit further includes side wall portions that rotatably support a roll that is the medium wound in a cylindrical shape, and a front plate that is positioned in front of the roll in a direction of drawing out the drawer unit from the housing, and
the finger-hooking portion is arranged in the front plate and the front plate is arranged below a rotation center of the roll in the direction of gravity.

3. The recording apparatus according to claim 1, wherein
the drawer unit is drawn out through an opening formed in the housing, and
the container further includes an outer wall portion that covers the opening when the container is fitted into the housing and an inner wall portion that forms the container unit between the inner wall portion and the outer wall portion.

4. The recording apparatus according to claim 3, wherein when the container is fitted into the housing, the opening is covered by the outer wall portion and the front plate, and an outer surface of the outer wall portion is flush with an outer surface of the front plate.

5. The recording apparatus according to claim 3, wherein
the container is attached at a position that is in line, in the direction of gravity, with the front plate of the drawer unit that is accommodated in the housing, and
a length of the outer wall portion and a length of the front plate in a width direction that intersects both the direction of gravity and the direction of drawing out the drawer unit are the same.
